(19) United States
(12) Patent Application Publication
(10) Pub. No.: US 2019/0307156 A1
(43) Pub. Date: Oct. 10, 2019

(54) NATURAL ENCAPSULATION FLAVOR PRODUCTS

(71) Applicant: McCormick & Company, Incorporated, Hunt Valley, MD (US)

(72) Inventors: Dmitriy ZASYPKIN, Cockeysville, MD (US); Shriram PARANJPE, Sparks,, MD (US); Michael REICK, Westminster, MD (US); Chungsea SHEN, Cockeysville, MD (US)

(73) Assignee: McCormick & Company, Incorporated, Hunt Valley, MD (US)

(21) Appl. No.: 16/315,359

(22) PCT Filed: Jul. 5, 2017
(86) PCT No.: PCT/US17/40704

§ 371 Date: Jan. 4, 2019

Related U.S. Application Data
(60) Provisional application No. 62/358,742, filed on Jul. 6, 2016.

(51) Int. Cl. A23L 27/00; A23L 2/56; A23L 27/10; A23P 10/35; A23P 30/20

(52) U.S. Cl. CPC A23L 27/72; A23L 2/56; A23L 27/10; A23G 2220/20; A23P 30/20; A23V 2002/00; A23P 10/35

(57) ABSTRACT

Natural encapsulation flavor products. Substantially natural particulate extrusion encapsulated flavor products are described including a flavor encapsulate, encapsulated in a natural glassy matrix, where the amount of flavor encapsulate encapsulated in the natural glassy matrix is based upon polarity of the flavor encapsulate as measured by dielectric constant.

### CROSS-REFERENCE TO RELATED APPLICATION

The instant application claims priority to U.S. Provisional Application No. 62/358,742 filed Jul. 6, 2016, the disclosure of which is expressly incorporated by reference in its entirety.

### TECHNICAL FIELD

The field of art to which this invention generally pertains is encapsulation technology, and specifically the encapsulation of active ingredients, such as flavors.

### BACKGROUND

The encapsulation of encapsulates is an area of active research. In particular, the encapstilation of encapsulates such as medications, pesticides (including insecticides, nematocides, herbicides, fungicides, microbiocides, etc.) preservatives, vitamins, flavoring agents, and other encapsulates, is desired for a number of reasons. In the case of medications, pesticides, and flavors encapsulation may be desired to achieve the controlled release of the medication, pesticide or flavor. For vitamins and flavors, encapsulation may be carried out to protect the vitamins and flavors from air-oxidation and, thus, to extend shelf life of the vitamins and flavors. In the case of flavoring agents, the encapsulation may also be carried out to place the flavoring in an easily metered form which will release the agent at a controllable event, such as the addition of water.

There is a constant search, especially in the food industry, to try to move away from artificial ingredients, and more toward natural ingredients. But such substitutions have been found to be challenging. In addition to the difficulty in finding one-for-one substitutions, the performance of natural ingredients does not always match the performance of their artificial counterparts, and predicting these differences, as well as similarities, in performance has itself been difficult at best.

The embodiments described herein address these challenges.

### BRIEF SUMMARY

A substantially natural particulate extrusion encapsulated flavor product is described, including a flavor encapsulate, encapsulated in a natural glassy matrix comprising at least one high molecular weight component, and at least one low molecular weight component, where the amount of flavor encapsulate encapsulated in the natural glassy matrix is increased to an amount equal to or greater than 5% by weight by increasing the polarity of the flavor encapsulate.

Additional embodiments include: the product described above where the flavor encapsulate has a polarity as measured by dielectric constant of greater than 5 and the amount of flavor encapsulate encapsulated in the natural glassy matrix is about 5% to about 8% by weight; the product described above where the flavor encapsulate has a polarity as measured by dielectric constant of greater than 10 and the amount of flavor encapsulate encapsulated in the natural glassy matrix is about 5% to about 12% by weight; the product described above where the high molecular weight components are present in an amount of up to about 90% by weight; the product described above where the high molecular weight component comprise maltodextrin, dextrin, fructans, larch gum or mixtures thereof; the product described above where the low molecular weight components are present in an amount of up to about 50% by weight; the product described above where the low molecular weight components comprise a sugar, a polyol, corn syrup solid, or mixtures thereof; the product described above where the low molecular weight components comprise maltose, trehalose, dextrose, lactose, fructose, xylose, sucrose, erythritol, maltitol, mannitol, xylitol, sorbitol, lactitol or mixtures thereof; the product described above where the glassy matrix additionally contains up to about 15% by weight of at least one insoluble natural fiber and up to about 15% by weight of at least one natural gum; the product described above where the natural gum is at least one of xanthan gum, pectin, alginate, konjac gum, locust bean gum, guar gum, hydrolyzed gelatin, whey protein, and carrageenan; the product described above where the insoluble natural fiber is apple fiber, blueberry fiber, citrus fiber, sugarcane fiber, oat fiber, wood fiber, cellulose fiber, microcrystalline cellulose fiber, cotton fiber, rice fiber, wheat fiber and/or mixtures thereof; the product described above where the flavor encapsulate is a natural flavor encapsulate; the product described above where the natural flavor is a natural extract, oleoresin, essential oil, protein hydrolyzate, reaction flavor, compounded flavor or mixtures thereof; the product described above additionally containing up to about 2% by weight of an emulsifier; the product described above where the emulsifier is a polysorbate or at least one natural emulsifier selected from the group of Quillaja extract, Yucca extract, soy saponins, and a lecithin; the product described above where the high molecular weight component contains up to 50% by weight gum Arabic, the flavor encapsulate has a polarity as measured by dielectric constant of less than 5 and the amount of flavor encapsulate encapsulated in the natural glassy matrix is about 5% to about 8% by weight; the product described above where the flavor encapsulate has a polarity as measured by dielectric constant of 5 to 10, and the amount of flavor encapsulate encapsulated in the natural glassy matrix is about 5% to about 12% by weight; and, the product described above where the flavor encapsulate has a polarity as measured by dielectric constant of greater than 10, and the amount of flavor encapsulate encapsulated in the natural glassy matrix is about 5% to about 15% by weight.

A method of making substantially natural particulate extrusion encapsulated flavor product is also described, including, in an extruder assembly, mixing and melting natural matrix components comprising at least one high molecular weight component, and at least one low molecular weight component, and a flavor encapsulate to form a viscous dispersion, shaping, extruding, and die-face cutting the viscous dispersion to form particulate extrusion encapsulation products, and drying and cooling the particulate extrusion encapsulation products to a glassy state, where the amount of flavor encapsulate encapsulated in the natural glassy matrix is increased to an amount equal to or greater than 5% by weight by increasing the polarity of the flavor encapsulate.

Additional embodiments include: the method described above where the flavor encapsulate has a polarity as measured by dielectric constant of greater than 5 and the amount of flavor encapsulate encapsulated in the natural glassy matrix is about 5% to about 8% by weight; the method described above where the flavor encapsulate has a polarity as measured by dielectric constant of greater than 10 and the amount of flavor encapsulate encapsulated in the natural glassy matrix is about 5% to about 12% by weight; the method described above where the high molecular weight components are present in an amount of up to about 90% by weight; the method described above where the high molecular weight component comprise maltodextrin, dextrin, fructans, larch gum, gum Arabic or mixtures thereof; the method described above where the low molecular weight components are present in an amount of up to about 50% by weight; the method described above where the low molecular weight components comprise a sugar, polyol, corn syrup solid, or mixtures thereof; the method described above where the low molecular weight components comprise maltose, trehalose, dextrose, lactose, fructose, xylose, sucrose, erythritol, maltitol, mannitol, xylitol, sorbitol, lactitol or mixtures thereof; the method described above additionally containing up to about 15% by weight of at least one insoluble natural fiber and up to about 15% by weight of at least one natural gum; the method described above where the natural gum is at least one of xanthan gum, pectin, alginate, konjac gum, locust bean gum, guar gum, hydrolyzed gelatin, whey protein, and carrageenan; the method described above where method of claim 27, wherein the insoluble natural fiber is apple fiber, blueberry fiber, citrus fiber, sugarcane fiber, oat fiber, wood fiber, cellulose fiber, microcrystalline cellulose fiber, cotton fiber, rice fiber, wheat fiber and/or mixtures thereof; the method described above where the flavor encapsulate is a natural flavor encapsulate; the method described above where the natural flavor is a natural extract, oleoresin, essential oil, protein hydrolyzate, reaction flavor, compounded flavor or mixtures thereof; the method described above where the product additionally contains up to about 2% by weight of an emulsifier; the method described above where the emulsifier is a polysorbate or at least one natural emulsifier selected from Quillaja extract, Yucca extract, soy saponins, and a lecithin; the method described above where the high molecular weight component contains up to 50% by weight gum Arabic, the flavor encapsulate has a polarity as measured by dielectric constant of less than 5 and the amount of flavor encapsulate encapsulated in the natural glassy matrix is about 5% to about 8% by weight; the method described above where the flavor encapsulate has a polarity as measured by dielectric constant of 5 to 10, and the amount of flavor encapsulate encapsulated in the natural glassy matrix is about 5% to about 12% by weight; and the method described above where the flavor encapsulate has a polarity as measured by dielectric constant of greater than 10, and the amount of flavor encapsulate encapsulated in the natural glassy matrix is about 5% to about 15% by weight.

A food system containing the particulate extrusion encapsulation product is also described, including the food system described above where the product is topically applied and/or mixed internally into the system; the food system described above including extruded cereal, crackers, cereal bars, snack chips, dough and frozen dough, bakery products such as, for example, bread and muffins, seasonings, ice cream, meat products, dairy products, and dry beverage blends.

These and additional embodiments are further described below.

### BRIEF DESCRIPTION OF THE DRAWINGS

The FIGURE demonstrates a differential scanning calorimetry (DSC) curve showing glass transition (glassy state) of an exemplary material described herein.

### DETAILED DESCRIPTION

The particulars shown herein are by way of example and for purposes of illustrative discussion of the various embodiments of the present invention only and are presented in the cause of providing what is believed to be the most useful and readily understood description of the principles and conceptual aspects of the invention. In this regard, no attempt is made to show details of the invention in more detail than is necessary for a fundamental understanding of the invention, the description making apparent to those skilled in the art how the several forms of the invention may be embodied in practice.

The present invention will now be described by reference to more detailed embodiments. This invention may, however, be embodied in different forms and should not be construed as limited to the embodiments set forth herein. Rather, these embodiments are provided so that this disclosure will be thorough and complete, and will fully convey the scope of the invention to those skilled in the art.

Unless otherwise defined, all technical and scientific terms used herein have the same meaning as commonly understood by one of ordinary skill in the art to which this invention belongs. The terminology used in the description of the invention herein is for describing particular embodiments only and is not intended to be limiting of the invention. As used in the description of the invention and the appended claims, the singular forms “a,” “an,” and “the” are intended to include the plural forms as well, unless the context clearly indicates otherwise. All publications, patent applications, patents, and other references mentioned herein are expressly incorporated by reference in their entirety.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Every numerical range given throughout this specification will include every narrower numerical range that falls within such broader numerical range, as if such narrower numerical ranges were all expressly written herein.

Additional advantages of the invention will be set forth in part in the description which follows, and in part will be obvious from the description, or may be learned by practice of the invention. It is to be understood that both the foregoing general description and the following detailed description are exemplary and explanatory only and are not restrictive of the invention, as claimed.

What is described herein relates to the discovery that the use of flavors with high flavor polarity is directly related to achieving high flavor load (above at least 4% by weight) in the encapsulation of flavors by melt extrusion when using natural matrices. Matrix components are considered substantially natural when they are extracted or produced through biotransformation without chemical modification. In this case biotransformation could include processes and aiding components (for example, enzymes) that do exist in nature. The natural matrices are typically comprised of blends of maltodextrins, dextrins, fructans such as inulin, natural gums, larch gum (up to 90% by weight), other extracted carbohydrates, and low molecular weight sugars or polyols. A way of characterizing the flavors by use of polarity is also described. The substantially natural particulate extrusion encapsulated flavor product includes a natural matrix made of natural matrix components, and could include natural or artificial flavors, emulsifiers, colors, anti-sticking and flow agents, and other minor processing aids as required.

In the past it has been difficult to encapsulate effectively more than 4% flavor loading by melt extrusion in natural carriers such as blends of maltodextrins and low molecular weight sugars, for example. The natural components do not have or have a limited emulsifying capacity in the melt, thus limiting effective flavor load. Flavor load above 4% provides greater flavor impact and can significantly reduce the cost-in-use of flavored compositions in various applications, thus providing many advantages. What has been determined and is described herein is that if the flavor polarity characterized by dielectric constant at 20° C. and at the electric field frequency of 10 kHz is in the range from about 5 to about 25, flavor load up to 8% (and more, e.g., up to 20% or 25%) in natural carriers can be achieved. This could essentially double (or more) the typical target flavor load. In addition, this flavor polarity can work synergistically with the addition of emulsifiers further increasing flavor load and making processing even more effective. Natural emulsifiers which can be used include Quillaja extract added to the matrix and sunflower lecithin added to the flavor, for example. High HLB (hydrophilic-lipophilic balance) emulsifiers (e.g. polysorbates) could be effective as well. The emulsifiers can be added to the flavor (typically, oil soluble emulsifiers), to the matrix, or even to a plastisizer added to the matrix in the process.

Polarity of a liquid flavor or solvent can be determined by measuring, for example, solubility in a variety of solvents, free energy of mixing and Hansen solubility parameters, calorimetry of mixing in various solvents, or dielectric constant. The latter is employed in this invention by using dielectric constant meter BI-870 (Brookhaven Instruments) that measures the electric current between the outer and inner cylinders of the probe. The measurement signal applied to the outer cylinder of the probe is a low-distortion sine electric wave at a frequency of 10 kHz. The temperature of sample and the frequency of applied electric field could affect the actual absolute readings of dielectric constant. The measurements described herein used 20° C. and 10 kHz as standard reference conditions, unless indicated otherwise. Other instruments, frequencies, or temperatures could be used for measurement of dielectric constants, with the numbers adjusted accordingly.

Typical natural matrix compositions typically hold about 4% by weight flavor. However, by incorporating the high polarity flavors described herein allows increasing the flavor load up to about 8% and more. The inclusion of some natural emulsifiers, such as Quillaja extract for example, in relatively high amounts, 3% or more for example, might be able to increase flavor load, but at these higher loadings adverse flavor effects (e.g., bitterness) can be introduced by the emulsifiers, and the use of these types of natural extracts can be costly, especially at the higher amounts required for higher flavor loading. The process described herein can get to even 8% or higher flavor loading without the extract, for example, although low levels of the extract, e.g., up to 1%, can be added to facilitate processing and further increase loading. This has been found to be true with the inclusion of some natural gums such as gum Arabic in the carrier as well. If the flavors are selected or modified such that their polarity is high, then flavor load can be increased even in non-emulsifying carriers.

As mentioned above, customers are very interested in natural consumables, such as encapsulation compositions, containing no artificial ingredients, both in the flavor and the matrix. However, low flavor load for these natural ingredients until now has meant higher cost, along with other limitations. This has been resolved as described herein with the ability to accomplish predictable high flavor load with compositions containing high polarity flavors and natural emulsifiers. In the past, the use of modified starches has been very beneficial for accomplishing higher flavor loads, but the starches are chemically modified. With the use of natural maltodextrins and sugars, without chemically modified starches, it is difficult to get to more than 4% flavor loads at best, while in the process described herein, with maltodextrins, 8%, 9%, 10% or even 12% flavor loading or more can be easily accomplished (including combinations of maltodextrins, dextrins, maltodextrin-gums, maltodextrin-sugar, natural gum-sugar, etc.).

By increasing flavor polarity, the flavor load can be increased. Flavor polarity is closely related to flavor solubility in oil, water, and other solvents, water soluble flavors on one end of the range being very polar, on the other side of the range oil soluble flavors being low polarity. By increasing polarity of the flavors above a certain level, flavor load in natural carriers can be increased as well. So polarity can drive the flavor selection and formulation. Conventional dielectric constant meters can be used to measure the polarity of the flavors, in terms of dielectric constant of the liquids (see copending, common assigned U.S. patent application Ser. No. (V49393) entitled Method of Predicting Flavor Performance, filed of even date herewith, the disclosure of which is herein incorporated by reference in its entirety).

The dielectric constant (DC) is typically measured at 20° C. for consistency at a fixed electric field frequency, for example 10 kHz, used as a reference in this invention unless indicated otherwise, and can be at least 5, and can go to 20, and even higher (e.g., 24, 25, 30, 40, 50, for example). Pure oils could have dielectric constant between 2 and 4 while water and water soluble flavors could have DC above 70. DC values would depend on the temperature and the applied electric field frequency. With DC below 5, it is problematic to encapsulate more than 4% flavor load in the natural carriers. Exceeding 4% flavor (total oil) load for these flavors would lead to problems such as extruder slippage, flavor leaks, surface oil too high, etc. If the polarity (DC value) gets too high for a flavor, for example, DC above 30, the flavor could become a plasticizer, and the encapsulation matrix with the flavor can become sticky and difficult to cut at the die. But there is otherwise virtually no limit on flavor polarity using the polarity described herein all the way to water soluble flavors.

Emulsification has been found to work better with high polarity flavors, for example, preventing flavor leaks and producing less surface oil in the final product. Maltodextrin-sugar compositions, with flavor loads above 4% by weight of the encapsulation composition in the past have had flavor leaks or loose flavor in any other form such as surface oil, steaming, spattering, etc.

Higher flavor loading provides many benefits. Not only can fewer flavor particles be used to impart the same flavor impact, with obvious cost benefits, but by having to add less flavor particles to obtain comparable flavor impact, there is less of any adverse impact on the other characteristics of the material the flavor is being added to, workability of a dough composition, for example, in addition to texture, structure, flavor, appearance, color, etc.

As the carrier material for the flavors described herein, conventional natural maltodextrins and low molecular weight sugars can be used, as well as natural gums, and natural emulsifiers such as Quillaja extract. The maltodextrins and sugars have lower molecular weight than the gums. Maltodextrins and sugars carry —OH groups on the molecules while gums in addition to —OH groups could have carboxylic and other groups. Typical compositions include 50 to 90% by weight maltodextrins (80%, for example) and about 10 to about 50% (20% for example) sugars. Other typical compositions include 50 to 90% by weight maltodextrins (80%, for example), 1 to 50% gums (5% pectin or xanthan gum, for example), and about 10 to about 50% (15% for example) sugars. Natural low molecular weight polyols, and corn syrup solids can also be used. See also, commonly assigned, copending U.S. Patent Application Ser. No. 62/270,797, the disclosure of which is herein incorporated by reference.

As mentioned above, low levels of Quillaja extract can assist in processing, lower surface oil levels, etc. e.g. at levels of 0.5 to 1%. Not only it is more costly to use higher amounts of this natural emulsifier, but at higher levels it can impart a bitter taste to the product being flavored. And the lower the polarity of the flavoring agent, the higher the surface oil (i.e., flavor), which can be more easily lost during processing. The preferred range of flavor polarity as measured by dielectric constant is from 5 to 20. At lower polarity, for example 4.7, the process could fail at flavor loads above 4%. Water dispersible or water soluble flavors have DC from 20 to 80, while oil soluble flavors have DC in the range from 2 to about 20. Most of the flavoring agents used are oil soluble.

The polarity of the flavor can also be shifted by using more polar flavor components or more polar solvents, or by increasing the concentration of flavor components in the flavor composition by reducing the amount of solvent. For example, with a cheese flavor, more of a butyric acid flavor component can be added to the flavor to make it more polar, resulting in increased flavor load as described herein. Alternatively, a more polar solvent, such as ethanol, for example, can be added to the flavor in place of a less polar solvent such as coconut oil, for example. This would shift the polarity of the flavor and increase the flavor load as described herein. Some care does need to be taken when selecting which solvent to add to which flavor to increase polarity, however. For example, ethanol may react with some flavors, such as fatty acid containing flavors, and form esters, which could result in a more fruity flavors. Selecting the wrong solvent could adversely impact solubility as well, for example. The use of some solvents, especially in large volumes, could also have an adverse impact on safety aspects during processing. Some representative solvents which can be used to increase polarity include ethanol, propylene glycol, glycerin, isopropanol, coconut oil, triacetin, etc.

Melt extrusion processes typically used for encapsulation of flavors and other materials can be used to form the particles described herein. The extruder assembly mixes dry blended matrix, with water or other plasticizers, and flavor, melt the blend and presses the viscous mass through a die typically with multiple holes. The individual components of the composition can be added either sequentially or at the same time, as long as all of the components are mixed and partially or completely melted prior to extrusion. A rotating cutter knife reduces the strands of the melt to particles. Depending on the linear speed of the extruded strands, rotating speed of the cutter, and the shape and size of the die holes, particles in the shape of rods, spheres or pillows, or relatively thin disks or flakes are formed. Then the particles are typically dried in conventional driers, for example, in a fluidized bed drier, and cooled to ambient temperature.

Some examples, as further described below, of the materials which can be used in the glassy matrix described herein include maltodextrins, gums, and low molecular weight carbohydrates. Maltodextrins are partially hydrolyzed forms of corn, rice, wheat, tapioca, or potato starches utilizing suitable acid and/or enzymatic hydrolysis. The maltodextrins are defined as having a Dextrose Equivalent (DE) of less or equal 20. The most suitable maltodextrins are the 5 DE, 6DE, 10 DE, 12DE, 15 DE, 16DE, 18 DE, and 19DE maltodextrins. DE characterizes average molecular weight of glucose oligomers by number. In practice, the maltodextrins have a distribution of glucose oligomers by molecular weight or DE value. Maltodextrin are typically present in the encapsulation composition from about 50% to about 90% by weight of the composition. Natural low molecular weight carbohydrates (below about 800 grams/mole) include, for example, maltose, trehalose, dextrose, lactose, fructose, xylose, sucrose, corn syrup solids, erythritol, maltitol, mannitol, xylitol, sorbitol, and lactitol. While any amounts may be used which accomplish the results described herein, the low molecular weight carbohydrates are typically present in an amount of about 5% to about 50% by weight and more typically about 10% to about 30% by weight. Natural gums that can be used could be low, medium, or high viscosity gums. Low viscosity gums could be, for example, gum Arabic, inulin, and larch gum. Medium viscosity gums could include, for example, pectin and carrageenan. High viscosity gums could include xanthan gum, alginate, locust bean gum, konjac gum, or mixtures thereof, for example.

Natural insoluble fibers can also be a part of the matrix composition. Fibers could provide viscosity control for the melt in the extrusion process and provide product integrity during cutting, drying, cooling, and storage. The natural insoluble fibers could include such things as apple fiber, blueberry fiber, citrus fiber, sugarcane fiber, oat fiber, wood fiber, cellulose fiber, microcrystalline cellulose fiber, cotton fiber, rice fiber, wheat fiber or mixtures thereof. Their typical level does not exceed 15%, more typically 10%, and even more typically 5% of the matrix composition by weight.

Plasticizers particularly useful with the processes, products and compositions disclosed herein include: water, ethanol, glycerin, propylene glycol, a carbohydrate solution and mixtures thereof. Depending on the amount of water, for example, already present or contained in the materials being added, although not typical, no additional water or other plasticizer may be needed to be directly added to the composition during the mixing to obtain the desired plasticizing effect.

Anti-sticking agents may also be used with the compositions described herein. Particularly useful with the processes and compositions disclosed herein are, alone or in combination: calcium, magnesium, sodium, and potassium salts of fatty acids; silicon dioxide; and titanium dioxide. If used, they are typically present in the product in amounts of about 0.25% to about 1% by weight.

The resultant encapsulated products can be used as part of any flavored food product or food system (topically applied and/or mixed internally into the system) such as extruded cereal, crackers, cereal bars, snack chips, dough and frozen dough, bakery products such as, for example, bread and muffins, seasonings, ice cream, meat products, dairy products, and dry beverage blends. When used in such systems, the encapsulated product is typically present in amounts up to about 3% by weight, for example, about 0.1% to about 1% percent flavor particles added.

See also the following examples and commonly assigned U.S. patents and pending and published patent applications for additional information relating to compositions, processes and products described herein, the disclosures of which are herein incorporated by reference: U.S. Pat. Nos. 5,603,971; 6,187,351: 6,790,453; 7,488,503; 7,799,341; 8,257,738; and 9,119,411; and U.S. Published Patent Applications Nos. 2013/0243851; 2014/0272011; and 2016/0058047.

### Example 1

A matrix composition which included 79.25% by weight of maltodextrins 5 DE and 10DE, 15% of sucrose, 5% pectin, and 0.75% magnesium stearate was dry blended and fed into the extruder assembly equipped with a 0.031″ multi-orifice die. Water and orange flavor were injected at about 11% and either 4% or 6% by weight of the final blend, respectively. The melt was extruded at a temperature in the range from about 145 to about 165° F. and die pressure from about 350 to about 650 psi (pounds per square inch). The orange flavor contained 50% single fold orange oil and various amounts of medium chain triglycerides (MCT), triacetin, isopropanol (IPA), and ethanol as a solvent; polysorbate 60 and sunflower lecithin as an emulsifier (Table 1). Solvents were chosen to vary polarity of flavor as quantified by dielectric constant measured at 20° C. After balancing the flows in about 20 min the process was either stable or became unstable with the extruder failing to maintain preset flow rate due to slipping. The slipping was an indication that the flavor was not effectively emulsified and the flavor load exceeded the limit for the matrix.

TABLE 1
Maximum flavor load as determined by flavor polarity and emulsifier.

| | | | Dielectric | Total flavor load, |
|---|---|---|---|---|
| Flavor part | Solvent | Emulsifier | constant | % w/w |
| 50% Orange | 45% MCT | 5% lecithin | 3.2 | 4% fails |
| 50% Orange | 50% MCT | none | 3.2 | 4% unstable |
| 50% Orange | 45% MCT | 5% Poly 60 | 3.3 | 4% runs well |
| 50% Orange | 40% MCT-5% ethanol | 5% lecithin | 4.1 | 4% fails |
| 50% Orange | 30% MCT-15% ethanol | 5% lecithin | 5.2 | 4% runs well |
| | | | | 6% fails |
| 50% Orange | 22.5% MCT-22.5% triacetin | 5% Poly 60 | 3.8 | 6% runs well |
| 50% Orange | 13.5% MCT-31.5% IPA | 5% Poly 60 | 6.4 | 6% runs well |
| 50% Orange | 13.5% MCT-31.5% IPA | 5% lecithin | 6.5 | 6% runs well |
| 50% Orange | 15% MCT-35% IPA | none | 6.2 | 6% runs well |
| | | | | slight surface oil |

### Example 2

A matrix composition which included 30% gum Arabic, 49.25% by weight of maltodextrins 5 DE and 10DE, 15% of sucrose, 5% pectin, and 0.75% magnesium stearate was dry blended and fed into the extruder assembly equipped with a 0.031″ multi-orifice die. Water and orange flavor were injected at about 12% and either 4% or 6% by weight of the final blend, respectively. The orange flavor contained 50% single fold orange oil, 45% MCT, and 5% sunflower lecithin. Dielectric constant of the flavor measured at 20° C. was 3.2. After balancing the flows in about 20 min the process was stable at 6% load with very slight surface oil on the particles. At 8% load the process became unstable with the extruder failing to maintain preset flow rate due to slipping. The slipping was an indication that the flavor was not effectively emulsified and the flavor load exceeded the limit of 6% for the matrix.

### Example 3

The composition and process of Example 1 was used to encapsulate a number of flavors at an increased flavor load (Table 2). As demonstrated in the table, 6% flavor load can be achieved with increased polarity of flavors.

TABLE 2
Maximum flavor load as determined by flavor polarity and emulsifier.

| | | | Dielectric | Total flavor load, |
|---|---|---|---|---|
| Flavor part | Solvent | Emulsifier | constant | weight % |
| Raspberry | none | none | 7.6 | 6% runs well* |
| Vanilla | 88.1% triacetin | none | 8.5 | 6% runs well |

*When the water content in the method is at 12% by weight and above

### Example 4

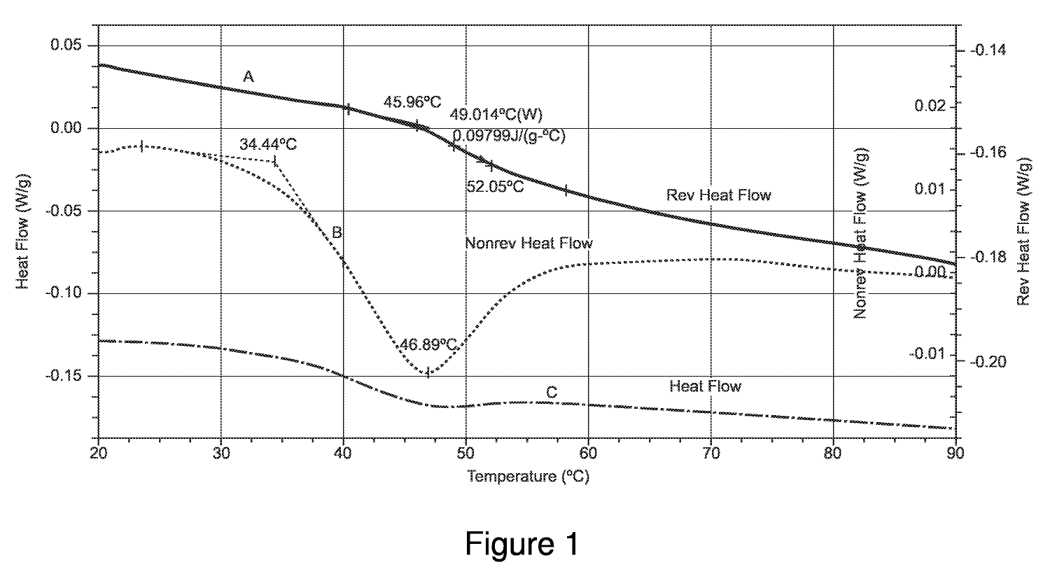

A matrix composition which included 74.25% by weight of maltodextrins 6 DE and 10DE, 15% of sucrose, 5% pectin, 5% sugarcane fiber, and 0.75% magnesium stearate was dry blended and fed into the extruder assembly equipped with a 0.031 inch multi-orifice die. Water and orange flavor were injected at 12% and 4% by weight of the final blend, respectively. The composition was extruded under process conditions described in Example 1. The orange flavor contained 50% single fold orange oil, 30% medium chain triglycerides (MCT), 15% ethanol, and 5% sunflower lecithin. Dielectric constant of the flavor was 5.2 at 20° C. After balancing the flows in about 15 min the product was collected and dried at 200° F. for 10 minutes. This resulted in glassy particles of 6.4% moisture (Karl-Fisher method), 49.0° C. midpoint glass transition temperature, and heat capacity change of 0.10 J/g/° C. (FIG. 1).

The FIGURE demonstrates a differential scanning calorimetry (DSC) curve showing glass transition (glassy state) of an exemplary material described herein. In the FIGURE, Rev stands for reversing, and Nonrev is non-reversing, and W/g is watts per gram. Curve A represents reversing or glass transition temperature heat flow, curve B represents the non-reversing or enthalpy relaxation component of total heat flow, and curve C represents total heat flow.

Thus, the scope of the invention shall include all modifications and variations that may fall within the scope of the attached claims. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A substantially natural particulate extrusion encapsulated flavor product, comprising:
a flavor encapsulate, encapsulated in
a natural glassy matrix comprising at least one high molecular weight component,
and at least one low molecular weight component,
wherein the amount of flavor encapsulate encapsulated in the natural glassy matrix is increased to an amount equal to or greater than 5% by weight by increasing the polarity of the flavor encapsulate.

2. The product of claim 1 wherein the flavor encapsulate has a polarity as measured by dielectric constant of greater than 5 and the amount of flavor encapsulate encapsulated in the natural glassy matrix is about 5% to about 8% by weight.

3. The product of claim 1 wherein the flavor encapsulate has a polarity as measured by dielectric constant of greater than 10 and the amount of flavor encapsulate encapsulated in the natural glassy matrix is about 5% to about 12% by weight.

4. The product of claim 1, wherein the high molecular weight components are present in an amount of up to about 90% by weight.

5. The product of claim 4, wherein the high molecular weight component comprise maltodextrin, dextrin, fructans, larch gum or mixtures thereof.

6. The product of claim 1, wherein the low molecular weight components are present in an amount of up to about 50% by weight.

7. The product of claim 1, wherein the low molecular weight components comprise a sugar, a polyol, corn syrup solid, or mixtures thereof.

8. The product of claim 7, wherein the low molecular weight components comprise maltose, trehalose, dextrose, lactose, fructose, xylose, sucrose, erythritol, maltitol, mannitol, xylitol, sorbitol, lactitol or mixtures thereof.

9. The product of claim 1, wherein the glassy matrix additionally contains up to about 15% by weight of at least one insoluble natural fiber and up to about 15% by weight of at least one natural gum.

10. The product of claim 9, wherein the natural gum is at least one of xanthan gum, pectin, alginate, konjac gum, locust bean gum, guar gum, hydrolyzed gelatin, whey protein, and carrageenan.

11. The product of claim 9, wherein the insoluble natural fiber is apple fiber, blueberry fiber, citrus fiber, sugarcane fiber, oat fiber, wood fiber, cellulose fiber, microcrystalline cellulose fiber, cotton fiber, rice fiber, wheat fiber and/or mixtures thereof.

12. The product of claim 1, wherein the flavor encapsulate is a natural flavor encapsulate.

13. The product of claim 12, wherein the natural flavor is a natural extract, oleoresin, essential oil, protein hydrolyzate, reaction flavor, compounded flavor or mixtures thereof.

14. The product of claim 1, additionally containing up to about 2% by weight of an emulsifier.

15. The product of claim 14, wherein the emulsifier is a polysorbate or at least one natural emulsifier selected from the group of Quillaja extract, Yucca extract, soy saponins, and a lecithin.

16. The product of claim 1, wherein the high molecular weight component contains up to 50% by weight gum Arabic, the flavor encapsulate has a polarity as measured by dielectric constant of less than 5 and the amount of flavor encapsulate encapsulated in the natural glassy matrix is about 5% to about 8% by weight.

17. The product of claim 16, wherein the flavor encapsulate has a polarity as measured by dielectric constant of 5 to 10, and the amount of flavor encapsulate encapsulated in the natural glassy matrix is about 5% to about 12% by weight.

18. The product of claim 16, wherein the flavor encapsulate has a polarity as measured by dielectric constant of greater than 10, and the amount of flavor encapsulate encapsulated in the natural glassy matrix is about 5% to about 15% by weight.

19. A method of making substantially natural particulate extrusion encapsulated flavor product comprising:
(i) in an extruder assembly, mixing and melting natural matrix components comprising at least one high molecular weight component, and at least one low molecular weight component, and a flavor encapsulate to form a viscous dispersion,
(ii) shaping, extruding, and die-face cutting the viscous dispersion to form particulate extrusion encapsulation products, and
(iii) drying and cooling the particulate extrusion encapsulation products to a glassy state,
wherein the amount of flavor encapsulate encapsulated in the natural glassy matrix is increased to an amount equal to or greater than 5% by weight by increasing the polarity of the flavor encapsulate.

20. The method of claim 19 wherein the flavor encapsulate has a polarity as measured by dielectric constant of greater than 5 and the amount of flavor encapsulate encapsulated in the natural glassy matrix is about 5% to about 8% by weight.

21. The method of claim 19 wherein the flavor encapsulate has a polarity as measured by dielectric constant of greater than 10 and the amount of flavor encapsulate encapsulated in the natural glassy matrix is about 5% to about 12% by weight.

22. The method of claim 19, wherein the high molecular weight components are present in an amount of up to about 90% by weight.

23. The method of claim 22, wherein the high molecular weight component comprise maltodextrin, dextrin, fructans, larch gum, gum Arabic or mixtures thereof.

24. The method of claim 19, wherein the low molecular weight components are present in an amount of up to about 50% by weight.

25. The method of claim 19, wherein the low molecular weight components comprise a sugar, polyol, corn syrup solid, or mixtures thereof.

26. The method of claim 25, wherein the low molecular weight components comprise maltose, trehalose, dextrose, lactose, fructose, xylose, sucrose, erythritol, maltitol, mannitol, xylitol, sorbitol, lactitol or mixtures thereof.

27. The method of claim 19, additionally containing up to about 15% by weight of at least one natural gum and up to about 15% by weight of at least one insoluble natural fiber.

28. The method of claim 27, wherein the natural gum is at least one of xanthan gum, pectin, alginate, konjac gum, locust bean gum, guar gum, hydrolyzed gelatin, whey protein, and carrageenan.

29. The method of claim 27, wherein the insoluble natural fiber is apple fiber, blueberry fiber, citrus fiber, sugarcane fiber, oat fiber, wood fiber, cellulose fiber, microcrystalline cellulose fiber, cotton fiber, rice fiber, wheat fiber and/or mixtures thereof.

30. The method of claim 19, wherein the flavor encapsulate is a natural flavor encapsulate.

31. The method of claim 30, wherein the natural flavor is a natural extract, oleoresin, essential oil, protein hydrolyzate, reaction flavor, compounded flavor or mixtures thereof.

32. The method of claim 19, wherein the product additionally contains up to about 2% by weight of an emulsifier.

33. The method claim 32, wherein the emulsifier is a polysorbate or at least one natural emulsifier selected from the group of Quillaja extract, Yucca extract, soy saponins, and a lecithin.

34. The method of claim 19, wherein the high molecular weight component contains up to 50% by weight gum Arabic, the flavor encapsulate has a polarity as measured by dielectric constant of less than 5 and the amount of flavor encapsulate encapsulated in the natural glassy matrix is about 5% to about 8% by weight.

35. The method of claim 34, wherein the flavor encapsulate has a polarity as measured by dielectric constant of 5 to 10, and the amount of flavor encapsulate encapsulated in the natural glassy matrix is about 5% to about 12% by weight.

36. The method of claim 34, wherein the flavor encapsulate has a polarity as measured by dielectric constant of greater than 10, and the amount of flavor encapsulate encapsulated in the natural glassy matrix is about 5% to about 15% by weight.

37. A food system containing the particulate extrusion encapsulation product of claim 1.

38. The food system of claim 37 wherein the product is topically applied and/or mixed internally into the system.

39. The food system of claim 37 comprising extruded cereal, crackers, cereal bars, snack chips, dough and frozen dough, bakery products such as, for example, bread and muffins, seasonings, ice cream, meat products, dairy products, and dry beverage blends.
